(19) United States
(12) Patent Application Publication
(10) Pub. No.: US 2022/0145188 A1
(43) Pub. Date: May 12, 2022

(54) FCC CO-PROCESSING OF BIOMASS OIL

(71) Applicant: ExxonMobil Research and Engineering Company, Annandale, NJ (US)

(72) Inventors: Hyung R. Kim, Basking Ridge, NJ (US); Jihad M. Dakka, Whitehouse Station, NJ (US); Xiaochun Xu, Basking Ridge, NJ (US)

(21) Appl. No.: 17/453,191

(22) Filed: Nov. 2, 2021

Related U.S. Application Data
(60) Provisional application No. 63/112,935, filed on Nov. 12, 2020.

(51) Int. Cl. C10G 3/00; C10G 47/30; C01B 3/12

(52) U.S. Cl. CPC C10G 3/52; C10G 3/57; C10G 3/62; C10G 47/30; C01B 3/12; C10G 2300/1011; C01B 2203/065; C10G 2300/42; C10G 2300/701; C10G 2300/4025; C01B 2203/0283; C01B 2203/062; C10G 2300/1074

(57) ABSTRACT

Systems and methods are provided for co-processing of biomass oil in a fluid catalytic cracking (FCC) system that include recovering an additional source of H₂ or synthesis gas from the overhead product gas stream. The additional H₂ can be used to partially hydrogenate biomass oil prior to co-processing the biomass oil in the fluid catalytic cracking system. Additionally or alternately, the additional synthesis gas can represent an additional yield of products from the process, such as an additional yield that can be used for synthesis of further liquid products.

### CROSS-REFERENCE TO RELATED APPLICATIONS

This application is related to and claims the benefit of priority from U.S. Provisional Application No. 63/112,935 filed Nov. 12, 2020, which is hereby incorporated by reference in its entirety.

### FIELD OF THE INVENTION

Systems and methods are provided for co-processing of biomass oil in a fluid catalytic cracking (FCC) unit.

### BACKGROUND OF THE INVENTION

Fluid catalytic cracking (FCC) processes are commonly used in refineries as a method for converting feedstocks, without requiring additional hydrogen, to produce lower boiling fractions suitable for use as fuels. Typical feedstocks can correspond to vacuum gas oil fractions, since lower boiling fractions are already within the fuels boiling range, while vacuum resid fractions are typically not as suitable for processing under FCC conditions.

Although conventional vacuum gas oil fractions are derived from mineral crude oils, oils derived from biomass can also be formed with boiling ranges similar to the vacuum gas oil boiling range. Some recent work has shown that co-processing of biomass oil with conventional feed can be performed in FCC units.

One of the difficulties with using FCC to process petroleum and/or renewable fractions is maintaining a desirable yield while also achieving high conversion of the input feed to fuel boiling range materials. The typical desired products from FCC processing are naphtha and light cycle oil. In addition to these desired products, however, FCC processing also generates a variety of other products. Compounds that have a higher boiling range than light cycle oil can be considered as “unconverted” compounds, as such higher boiling range compounds are likely to either be recycled again for further cracking or used as fuel oil. Compounds that are lighter than the naphtha boiling range correspond to light ends that are also low in value relative to liquid products. Additionally, a portion of the feed to an FCC process is converted to coke that forms on the catalyst. Conventional FCC designs use this coke to provide heat for the FCC reaction, so coke needs to be consumed for the reactor to stay in thermal balance. However, this coke consumption still represents a net loss in yield from the original amount of fresh feed.

It would be desirable to have systems and methods that can further improve the ability to co-process biomass oil in an FCC reactor and/or that can improve on the product value generated from co-processing of biomass oil in an FCC reactor. In particular, it would be desirable to have systems and methods that can allow for co-processing of biomass oil while maintaining or even improving the net yield from the process.

### SUMMARY OF THE INVENTION

In an aspect, a method for co-processing biomass is provided. The method includes exposing a biomass oil to hydrogenation conditions in the presence of at least a portion of an H₂-containing fraction to form a partially hydrogenated biomass oil having an oxygen content of 2.0 wt % or more. The method further includes exposing at least a portion of the partially hydrogenated biomass oil and a feedstock containing a vacuum gas oil boiling fraction to a catalyst in a reactor under fluid catalytic cracking conditions to form a C₄₋ fraction and one or more liquid product fractions, the at least a portion of the partially hydrogenated biomass oil containing 10 wt % or more of a combined weight of the at least a portion of the partially hydrogenated biomass oil and the feedstock. The method further includes separating a fraction containing C₃-C₄ hydrocarbons and an overhead product gas fraction containing CO from the C₄ fraction. Additionally, the method includes contacting at least a portion of the overhead product gas fraction with a water gas shift catalyst to form at least the H₂-containing fraction.

In another aspect, a method for co-processing biomass is provided. The method includes exposing a biomass oil having an oxygen content of 5.0 wt % or more and a feedstock containing vacuum gas oil to a catalyst in a reactor under fluid catalytic cracking conditions to form a C₄ fraction and one or more liquid product fractions, the biomass oil corresponding to 10 wt % or more of a combined weight of the biomass oil and the feedstock. The method further includes separating a fraction comprising C₃-C₄ hydrocarbons and an overhead product gas fraction from the C₄ fraction. Additionally, the method includes contacting at least a portion of the overhead product gas fraction with a water gas shift catalyst to form a fraction containing H₂ and CO.

In still another aspect, a biomass co-processing system is provided. The system includes a biomass conversion unit comprising a biomass inlet and a conversion product outlet. The system further includes a hydrogenation stage comprising a hydrogenation feed inlet, a hydrogen inlet, and a hydrogenated product outlet, the hydrogenation feed inlet being in fluid communication with the conversion product outlet. The system further includes an FCC reactor comprising an FCC feed inlet, a regenerated catalyst inlet, a spent catalyst outlet, a reactor gas outlet, and a one or more product outlets, the FCC feed inlet being in fluid communication with the hydrogenated product outlet and a second feed source. The system further includes a gas plant comprising a gas plant inlet, one or more gas plant product outlets, and an overhead product outlet, the gas plant inlet being in fluid communication with the reactor gas outlet. The system further includes an FCC regenerator comprising a regenerator gas inlet, a regenerator flue gas outlet, a spent catalyst inlet in solids flow communication with the spent catalyst outlet, and a regenerated catalyst outlet in solids flow communication with the regenerated catalyst inlet. Additionally, the system includes a water gas shift reaction stage comprising a shift reaction inlet and a shift reaction outlet, the shift reaction inlet being in fluid communication with the overhead product outlet of the gas plant, the shift reaction outlet being in fluid communication with the hydrogen inlet of the hydrogenation stage.

### BRIEF DESCRIPTION OF THE FIGURES

FIG. 1 shows an example of a reaction system for co-processing of biomass oil in a FCC unit.

FIG. 2 shows another example of a reaction system for co-processing of biomass oil in a FCC unit.

FIG. 3 shows liquid product yields from FCC processing of various feeds.

FIG. 4 shows CO yields from FCC processing of various feeds.

FIG. 5 shows CO yields from FCC processing of various feeds.

FIG. 6 shows CO yields from FCC processing of a feed at varying levels of feed conversion.

FIG. 7 shows CO yields from FCC processing of a model compound feed.

FIG. 8 shows CO yields from FCC processing of another model compound feed.

### DETAILED DESCRIPTION OF THE INVENTION

All numerical values within the detailed description and the claims herein are modified by “about” or “approximately” the indicated value, and take into account experimental error and variations that would be expected by a person having ordinary skill in the art.

### Overview

In various aspects, systems and methods are provided for increasing the yield of products generated during co-processing of biomass oil in a fluid catalytic cracking (FCC) system by recovering an additional source of synthesis gas from the overhead product gas stream. It has been discovered that co-processing of 10 wt % or more of biomass oil in an FCC reactor can result in production of CO in the overhead product gas stream while maintaining the yield of the primary liquid products from the FCC reactor. In aspects where the additional CO is used to form synthesis gas (such as by using a water gas shift reaction stage), any fuel products formed from the synthesis gas (such as methanol or Fischer-Tropsch products) represent an increased yield of liquid products.

Additionally or alternately, in various aspects, systems and methods are provided for increasing the volume of biomass oil that can be co-processed in an FCC system without having to introduce additional hydrogen into the system. In such aspects, at least a portion of the additional CO in the overhead product gas stream can be converted to H₂. The H₂ from the overhead product gas can then be used in a partial hydrogenation process for the biomass oil prior to co-processing. Partially hydrogenating the biomass oil can reduce or minimize components in the biomass oil that may interfere with the catalytic activity of the catalyst in the FCC reactor, while still preserving sufficient oxygen in the partially hydrogenated biomass oil to obtain the additional CO in the overhead product gas. For example, aromatic compounds with one or more attached alcohol groups (e.g., phenols) have an increased likelihood to result in coke formation as opposed to liquid products. By performing a partial hydrogenation, at least a portion of the aromatic alcohols in the biomass oil can be converted to non-aromatic cyclic ketones. Such aliphatic compounds are more readily converted to liquid products. In addition to reducing coke formation, partial hydrogenation can also reduce the tendency for biomass oil to foul the input feed lines to the FCC reaction system. Thus, partial hydrogenation can extend the run length for a reaction system between maintenance events.

The hydrogen recovery and/or synthesis gas recovery can be achieved in part by using a water gas shift reaction to convert at least a portion of the CO in the overhead product stream into H₂ and/or to adjust the molar ratio of H₂ to CO to a value of roughly 2.0. It is noted that steam can be added to facilitate the desired outcome from the water gas shift reaction.

Conventionally, fluid catalytic cracking (FCC) processes are used to convert mineral vacuum gas oil fractions into lower boiling range products. One of the challenges in conventional FCC processing is achieving a high conversion of a feedstock while also forming valuable and/or desired products. Some of the desired product from FCC processing are liquid products that can be used in fuel fractions. This can include naphtha boiling range products and cycle oils. Other conventionally desired products from FCC processing can include C₃-C₄ olefins. In addition to the typical desired products, FCC processing can also result in the production of C₄₋ compounds. The C₃ and C₄ alkanes can be separate out for use as liquefied petroleum gas (LPG). The remaining C₂₋ compounds, as well as any other low boiling compounds, correspond to an overhead gas product. These products are generated during an FCC process by catalytic cracking of mineral vacuum gas oil boiling range feeds.

The conversion products in the overhead product gas are typically a small portion of the total FCC product, corresponding to 1.0 wt % to 6.0 wt % of the total yield (including coke) relative to the weight of the input feedstock. The overhead product gas from FCC processing is typically formed in a gas plant, where one or more separations are performed on a light ends fraction from the FCC main column to allow for recovery of C₃ and/or C₄ olefins (optionally for use in alkylation) and recovery of LPG. The gas plant can also remove/separate out contaminant gases, such as H₂S and/or NH₃, as well as removing any fine particulates that may be entrained in the gas flow. This leaves a remaining stream corresponding to an overhead gas product that includes a C₂₋ fraction, along with any other low boiling compounds (such as N₂). When co-processing of biomass is performed with 10 wt % or more of biomass in the input feedstock, this overhead gas product can also include CO. It is noted that the gas plant is a standard part of a conventional FCC reaction system.

Conventionally, the C₂₋ fraction considered a low value product, as it primarily contains methane and ethane. Additionally, the C₂₋ fraction may be diluted with other components, such as N₂ from the reaction environment. However, because conventional FCC feeds typically have substantially no oxygen content, CO and CO₂ are typically not present in the C₂₋ fraction derived from an FCC overhead product gas. Conventionally, the C₂₋ fraction from the FCC main column is typically used as a fuel gas in the refinery, or for another low value use. It is noted that a conventional FCC C₂₋ fraction can also include 0.10 wt % to 0.15 wt % of H₂, relative to the weight of the input feed to the FCC process.

While FCC conversion of vacuum gas oil feeds is effective for production of naphtha and cycle oils, a long term goal of many refineries is to increase the utilization of renewable feedstock. Using biomass oil as a co-feed during FCC processing provides an option for increasing the renewable content of fuels formed at a refinery while reducing or minimizing the amount of new processing stages that are required. Unfortunately, attempting to co-process pyrolysis oil in a FCC reaction system can pose several additional challenges. First, due to the nature of some compounds in biomass oil, a feed including biomass oil can tend to deactivate FCC catalyst and/or can tend to foul the input flow line to the FCC reaction system. Second, the relatively high oxygen contents of many types of biomass oil could potentially reduce the yield of high value products from an FCC reaction system, due to formation of H₂O, CO, CO₂ or other lower value products.

In some aspects, a partial hydrogenation stage can be used to improve the quality of the biomass oil. In such aspects, the hydrogen for the partial hydrogenation stage can be provided from the overhead gas product from the FCC reactor. Additional hydrogen for this partial hydrogenation can be provided by using a water gas shift reaction stage to convert CO produced in the FCC reactor into H₂. When processing a conventional vacuum gas oil feed, CO is not produced under FCC reaction conditions. However, when biomass oil containing oxygen is fed, the overhead gas product can contain CO. The partial hydrogenation can be used to improve the quality of the biomass oil while still leaving behind a substantial amount of oxygen in the partially hydrogenated biomass oil. By using H₂ derived from the overhead gas, the run length of the FCC process can be improved without needing to provide a separate source of H₂ to partially hydrogenate the biomass oil. Additionally, producing a partially hydrogenated biomass oil that still contains oxygen can allow additional CO to be produced in the FCC reactor that can subsequently be shifted to form H₂.

In other aspects, instead of using the CO in the overhead product gas to form H₂, the water gas shift reaction stage can be used to generate a synthesis gas with a molar ratio of H₂ to CO of roughly 2.0 (i.e., roughly 2:1). This synthesis gas can then be used to supplement the liquid product yield from co-conversion of biomass. It has further been discovered that the yield of naphtha and light cycle oil, the two most desirable liquid products from an FCC reactor, can be maintained at substantially the same level during co-processing of biomass oil, as compared with processing only a conventional feed. Thus, using the synthesis gas contained in the product overhead gas provides a way to increase the yield of naphtha and light cycle oil when co-processing biomass oil in an FCC reactor.

Providing a water gas shift stage to form hydrogen and/or synthesis gas from the C₂₋ fraction (i.e., the CO-containing fraction) can provide other synergistic integration opportunities. For example, for some types of feeds, additional CO can be recovered from the regenerator flue gas. FCC processing involves management or balancing of several constraints. One constraint is that hydrogen is not separately added to the FCC processing environment. Thus, the total product slate generated from FCC processing will have the same molar ratio of carbon to hydrogen as the input feedstock. However, naphtha boiling range fractions typically have a lower molar ratio of carbon to hydrogen than vacuum gas oil boiling range feeds. As a result, a portion of the feedstock in an FCC process is typically converted into coke that forms on the FCC catalyst. In a conventional FCC process, this coke can be combusted in the regenerator for the FCC system to provide heat for the reactor. While this is an effective use of the coke, the resulting CO₂ generated from the combustion corresponds to carbon that is lost from the yield of desired products. For some types of FCC feeds, however, the FCC reaction conditions may result in generation of more coke than is needed in the regenerator in order to maintain heat balance with the reactor. In such aspects, one option for achieving the desired heat balance is to operate the regenerator in a partial regeneration mode. In addition to reducing the amount of heat generated per carbon that enters the regenerator, operating in partial oxidation mode also results in production of CO. This CO can be added to the CO from the overhead product gas to form additional hydrogen and/or synthesis gas. Operating in partial regeneration mode can be achieved, for example, by operating the FCC regenerator so that the amount of oxygen in the FCC regenerator is low relative to the stoichiometric amount of oxygen that would be needed for complete combustion of coke on the catalyst passed into the regenerator.

Still another opportunity for synergistic integration can be provided by the conversion process for converting the biomass to biomass oil. In addition to forming biomass oil, a pyrolysis, hydrothermal liquefaction, or other biomass conversion process can typically generate a light gas fraction that also contains CO. Thus, the light gas fraction from a biomass conversion process provides a third potential gas stream that can be exposed to a water gas shift reaction for production of synthesis gas. It is noted, however, that the light gas fraction from biomass conversion may contain a variety of products that would not normally be introduced in large quantities into a water gas shift reaction environment. Thus, addition of the light gas fraction from biomass conversion to the other CO-containing streams would require performing additional separations on the light ends from biomass conversion.

In various aspects, the yield of CO in the FCC overhead product gas and/or the CO-containing fraction, relative to the total input feed to the FCC main column, can be 0.1 wt % to 1.5 wt %, or 0.1 wt % to 1.0 wt %, or 0.1 wt % to 0.6 wt %, or 0.2 wt % to 1.0 wt %, or 0.2 wt % to 1.5 wt %, or 0.2 wt % to 0.6 wt %. It is noted that if this amount of CO is fully shifted to provide H₂, due to the lower molecular weight of H₂, this corresponds to a potential yield of H₂ of 0.007 wt % to 0.07 wt %, or 0.007 wt % to 0.05 wt %, or 0.014 wt % to 0.07 wt %, or 0.014 wt % to 0.05 wt %, relative to the weight of the fresh feed to the FCC reactor. It is noted that a conventional yield of H₂ from an FCC reactor can be between 0.05 wt % and 0.15 wt %. In various aspects, the amount of CO in the overhead product gas stream, relative to the weight of the overhead product gas, can be 5.0 wt % to 50 wt %, or 5.0 wt % to 20 wt %, or 10 wt % to 50 wt %.

In some aspects, the FCC overhead product gas can then be exposed to a water gas shift catalyst for conversion of CO to H₂. Because of the separations performed in the gas plant, the overhead product gas can be exposed to a water gas shift reaction environment without further separation. This results in formation of a shifted overhead gas product. After shifting the H₂ to CO ratio, a suitable separation step can be performed to separate a stream containing H₂ and optionally CO from the shifted overhead gas product.

In addition to the yield of CO from the FCC overhead product gas, a similar amount of CO can be provided by the regenerator flue gas when the regenerator is operated under partial oxidation conditions. Although the CO concentration in the regenerator flue gas can be higher, the regenerator is producing CO from coke generated during FCC processing. Optionally, a separation may be performed on the regenerator flue gas to remove NOx and/or SOx prior to adding the regenerator flue gas to the input flow(s) for the water gas shift reaction environment.

### Definitions

In this discussion, the FCC overhead product gas is defined as corresponding to product compounds that contain zero, one, or two carbon atoms (i.e., H₂O, H₂, CO, CO₂, methane, and C₂ hydrocarbons). It is noted that other components may be present in the overhead stream from the FCC main reactor column (such as N₂) that correspond to gases introduced into the FCC reaction environment and then exit without undergoing a chemical reaction. These diluents are not strictly “products” of the FCC reaction, and therefore are not included when determining the weight of the overhead product gas.

In this discussion, a biomass conversion product corresponds to any product generated by exposure of biomass to a conversion process. Pyrolysis processes, such as fast pyrolysis or hydrothermal liquefaction, are examples of conversion processes. Other types of conversion processes can include, but are not limited, to, physical and chemical conversion processes that result in production of a liquid biomass product. This can include processes for recovering a product such as a vegetable oil (e.g., canola oil) from a biomass source. In this discussion, “biomass light gas” is defined as any conversion products from a biomass conversion process that would be gas phase at 20° C. and 100 kPa-a. In this discussion, “biomass oil” is defined as any conversion products from a biomass conversion process that would be liquid phase at 20° C. and 100 kPa-a. It is noted that biomass oil has a boiling range that is broader than the boiling range for a vacuum gas oil that would typically be used as an FCC feed.

As defined herein, the term “hydrocarbonaceous” includes compositions or fractions that contain hydrocarbons and hydrocarbon-like compounds that may contain heteroatoms typically found in petroleum or renewable oil fraction and/or that may be typically introduced during conventional processing of a petroleum fraction. Heteroatoms typically found in petroleum or renewable oil fractions include, but are not limited to, sulfur, nitrogen, phosphorous, and oxygen. Other types of atoms different from carbon and hydrogen that may be present in a hydrocarbonaceous fraction or composition can include alkali metals as well as trace transition metals (such as Ni, V, or Fe).

In this discussion, conversion of a feed within an FCC reactor is defined based on the amount of feed that is converted from 343° C.+ compounds to 343° C.− compounds. Thus, when describing reaction conditions based on conversion of a feed, the reaction conditions can be specified based on the wt % of 343° C.+ compounds that are converted during the reaction. For example, specifying reaction conditions that correspond to 60 wt % conversion of a feed means that relative to the original amount of 343° C.+ compounds present in the feed, 60 wt % of those compounds are converted to products with boiling points of 343° C. or less. The remaining 40 wt % of the 343° C.+ compounds in the feed correspond to “unconverted” portions of the feed. This does not necessarily mean that the remaining 40 wt % of the feed is unreacted. It only means that 40 wt % of the feed still had boiling points above 343° C. after the reaction.

In various aspects, reference may be made to one or more types of fractions generated during distillation of a petroleum feedstock. Such fractions may include naphtha fractions, kerosene fractions, diesel fractions, and vacuum gas oil fractions. Each of these types of fractions can be defined based on a boiling range, such as a boiling range that includes at least ˜90 wt % of the fraction, or at least ˜95 wt % of the fraction. For example, for naphtha fractions, at least ˜90 wt % of the fraction, or at least ˜95 wt %, can have a boiling point in the range of ˜85° F. (˜29° C.) to ˜430° F. (˜221° C.). For some heavier naphtha fractions, at least ˜90 wt % of the fraction, or at least ˜95 wt %, can have a boiling point in the range of ˜85° F. (˜29° C.) to ˜400° F. (˜204° C.). For a light cycle oil (LCO) fraction, at least 90 wt %, or at least 95 wt %, of the fraction can have a boiling point in the range of ˜430° F. (˜221° C.) to ˜650° F. (˜343° C.). For a (vacuum) gas oil fraction, at least ˜90 wt % of the fraction, and preferably at least ˜95 wt %, can have a boiling point in the range of ˜650° F. (˜343° C.) to ˜1100° F. (˜593° C.). It is noted that 343° C.+ fractions used as feeds may be referred to as vacuum gas oil boiling range fractions, while an FCC product fraction of 343° C.+ compounds can be referred to as an unconverted fraction.

In this discussion, a liquid fuel product yield can be referred to. The liquid fuel product yield is defined herein as the combined amount of naphtha (29° C.-221° C.) and light cycle oil (221° C. to 343° C.) yield generated in the FCC reactor, relative to the weight of the fresh input feed (either conventional or biomass oil). In this discussion, yields of other products, such as CO, are also specified relative to the weight of fresh input feed to the FCC reactor, unless stated otherwise.

### Formation of Biomass Oil

The biomass used as feed for a biomass conversion process can be any convenient type of biomass. Examples of suitable biomass sources can include woody biomass and switchgrass. More generally, the biomass used as feed for a biomass conversion process can be any convenient type of biomass. Some forms of biomass can include direct forms of biomass, such as algae biomass and plant biomass. Other forms of biomass may correspond to waste products, such as food waste, animal waste, paper, and/or other waste products originally formed from biomass materials. In this discussion, municipal solid waste is included within the definition of biomass, even though a portion of the solids in municipal solid waste may not strictly correspond to solids derived from biomass.

In addition to carbon, oxygen, and hydrogen, depending on the form of the biomass, other heteroatoms may be present such as nitrogen, phosphorus, sulfur, and/or various metals. Biomass can generally have a molar ratio of hydrogen to carbon of 2:1 or less, but that is typically accompanied by a substantial amount of oxygen. Thus, conversion of biomass without using additional hydrogen typically results in production of liquid products (e.g., biomass oil) with hydrogen to carbon molar ratios substantially below 2:1. This is part of why co-processing in an FCC unit is desirable for biomass oil, as FCC processing provides a way to upgrade biomass oil to fuel products/fuel blending products without having to add substantial amounts of hydrogen to the reaction environment.

In aspects where the biomass is introduced into a reaction environment at least partially as solids, having a small particle size can facilitate transport of the solids into the reactor or other reaction environment. In some instances, smaller particle size can potentially also contribute to achieving a desired level of conversion of the biomass under the short residence time conditions. Thus, one or more optional physical processing steps can be used to prepare solid forms of biomass for conversion. In such optional aspects, the solids can be crushed, chopped, ground, or otherwise physically processed to reduce the median particle size to 3.0 cm or less, or 2.5 cm or less, or 2.0 cm or less, or 1.0 cm or less, such as down to 0.01 cm or possibly still smaller. For determining a median particle size, the particle size is defined as the diameter of the smallest bounding sphere that contains the particle.

Biomass oil can be formed from biomass using any convenient conversion process that does not involve substantial addition of H₂ to the conversion environment. Various types of pyrolysis processes are some examples of biomass conversion processes, such as fast pyrolysis, catalytic pyrolysis, or hydrothermal liquefaction.

Hydrothermal liquefaction is a process where biomass is exposed to an aqueous reaction environment at temperatures between 250° C. to 550° C. and pressures of roughly 5 MPa-a to 2.5 MPa-a. In many instances, a catalyst is also included in the reaction environment, such as an alkali metal catalyst. The biomass is exposed to the aqueous reaction environment under the hydrothermal liquefaction conditions for a period of 10 minutes to 60 minutes. The resulting products (biomass light gas, biomass oil) can then be separated from the aqueous environment.

Another type of conversion process can be a fast pyrolysis process. During pyrolysis, the biomass is exposed to temperatures of 450° C. to 600° C. in a substantially O₂-free environment. The biomass oil can then be condensed from the resulting vapors formed by the pyrolysis process. A variation on a fast pyrolysis process can be a catalytic fast pyrolysis process. The catalyst in a catalytic fast pyrolysis process can be, for example, an acidic catalyst, such as a silica catalyst, an alumina catalyst, or a zeotype catalyst. Catalytic fast pyrolysis can be used to increase the rate of conversion of the biomass to products.

In various aspects, such as aspects involving pyrolysis, the biomass conversion process can generate at least a light gas product and biomass oil. (It is noted that other types of conversion processes may generate only a plurality of liquid products, rather than generating at least one light gas product.) Many types of conversion processes can also generate char or other solid products formed primarily from carbon. The biomass oil can generally correspond to C₅₊ hydrocarbonaceous compounds that are formed during the biomass conversion process, although other compounds could be present if they are liquid at 20° C. and 100 kPa-a. The oxygen content of the biomass oil can vary depending on the nature of the conversion process used to form the biomass. In some aspects, the oxygen content of the biomass oil can be between 2.0 wt % to 60 wt %, or 2.0 wt % to 50 wt %, or 5.0 wt % to 60 wt %, or 5.0 wt % to 50 wt %, or 10 wt % to 60 wt %, or 10 wt % to 50 wt %. It is noted that the range of oxygen contents may be somewhat lower for biomass oil formed by certain methods, such as hydrothermal liquefaction. In some aspects, the biomass oil can have an oxygen content of 5.0 wt % to 20 wt %, or 5.0 wt. % to 15 wt. %.

The light gas product can generally include C₄₋ hydrocarbonaceous compounds, as well as CO, CO₂, and H₂O. Various contaminant gases are usually present, such as NH₃ or H₂S. Additionally, small particulates can be entrained in the light gas product, such as catalyst particles and/or char particulates formed during the pyrolysis. Because of the presence of the contaminant gases and the small particulates, one or more separations would need to be performed prior to using a portion of the light gas product as a CO source. This could exclude, for example, an amine wash for removal of H₂S and a cyclone or other gas-solids separator for removing the entrained particulates. The amount of CO in the light gas product can vary depending on the nature of the biomass and process conditions. In some aspects, the amount of CO in the light gas product can correspond to 5.0 vol % to 15 vol % of the light gas product.

### Performing Water Gas Shift Reaction on CO-Containing Gas Stream(s)

In various aspects, a water gas shift reaction stage can be used to convert at least a portion of the CO in one or more gas streams into H₂. The water gas shift reaction is a fast equilibrium reaction. The stoichiometry of the water gas shift reaction is shown in Equation (1).

H₂O+CO<=>H₂+CO₂ (1)

Generally, the water gas shift reaction can be performed at shift conditions that include temperatures of 200° C. to 500° C. A variety of catalysts are available that provide water gas shift reaction activity. This can include catalysts that contain various metals from Groups 8-10 of the IUPAC periodic table, such as nickel, rhodium, cobalt, iron, and/or platinum. Additionally or alternately, some water gas shift catalysts can include copper, chromium, and/or zinc. One example of a low temperature water gas shift catalyst is a catalyst containing roughly 30 wt % to 35 wt % CuO, 30 wt % or more of ZnO, with the balance being alumina. Low temperature water gas shift conditions can include exposing a feed to temperatures of 200° C. to 300° C. in the presence of the water gas shift catalyst. One example of a high temperature water gas shift catalyst is a catalyst based on iron oxide that includes chromium oxide and optional magnesium oxide. High temperature water gas shift reactions can be performed at temperatures from 300° C. to 500° C., or 300° C. to 450° C.

Because the water gas shift reaction is an equilibrium reaction, the direction of the reaction can be driven in part by the amounts of the various reactants. Thus, when converting CO to H₂, one option for controlling the amount of H₂ that is produced can be by controlling the amount of H₂O and/or CO₂ present in the reaction environment. As the concentration of H₂O is increased, the water gas shift reaction will be driven toward production of H₂. Similarly, as the amount of CO₂ is increased, the water gas shift reaction will be driven toward production of CO.

The overhead product stream from an FCC reactor, when processing a conventional feedstock, typically contain only low levels (and possibly none) of either H₂O or CO₂. This is due in part to the low concentrations of oxygen in conventional FCC feedstocks. When biomass oil is co-processed, the amount of oxygen in the total feed can still be relatively low, so the CO₂ concentration and the H₂O concentration in the overhead product gas (and the corresponding CO-containing fraction derived from the overhead product gas) can be similar to or lower than the CO concentration. For this type of overhead product gas composition, conversion of CO to H₂ can be facilitated by addition of steam to the water gas shift reaction environment. The amount of steam added can depend on various factors, including the initial CO concentration in the flue gas and the desired products. If it is desired to make H₂, then a greater amount of steam can be added to drive the reaction toward complete conversion of CO to H₂. In other aspects where it is desired to make synthesis gas, a lower amount of steam can be added in an effort to try to achieve a roughly 2:1 molar ratio of H₂ to CO. For example, the water gas shift conditions can be selected to achieve a molar ratio of H₂ to CO of 1.8 to 2.2.

In addition to the CO-containing fraction derived from the overhead product gas from the FCC reactor, other streams from the integrated system can also optionally be passed into the water gas shift reaction stage for additional generation of H₂ and/or synthesis gas. For example, at least a portion of the flue gas from the FCC regenerator can be introduced into the water gas shift reaction stage in aspects where the regenerator is operated under partial oxidation conditions. When operated under partial oxidation conditions, the regenerator can be oxygen deficient relative to the stoichiometric amount of oxygen that would be needed to combust all coke on the catalyst as the catalyst passes through the regenerator. Under this type of condition, instead of forming almost exclusively CO₂, the regenerator flue gas can include 30 vol % or more, or 50 vol % or more of CO, such as up to 80 vol % or possibly still higher. The flue gas from the regenerator can be substantially composed of CO, CO₂, N₂ (if air is used as the oxygen source), and H₂O. As a result, the flue gas from the regenerator can be suitable for exposure to the water gas shift catalyst.

Still another stream that can be used as a source of CO for the water gas shift reaction stage is light gas stream from biomass conversion. The light gas stream from biomass conversion can potentially contain a variety of additional components, such as SOx or NOx, so it may be desirable to perform a separation on the light gas stream from biomass conversion to separate out sulfur and/or nitrogen compounds prior to exposure to the water gas shift catalyst.

The water gas shift reaction stage can generate at least one of a hydrogen-containing stream and a syngas-containing stream. In some aspects H₂ can be the desired product. In such aspects, such as when using the H₂ to perform partial hydrogenation on the biomass oil, the yield of H₂ from the shifted product overhead gas (relative to the amount of fresh co-processed feed introduced into the reactor) can be 0.01 wt % to 0.5 wt %, or 0.1 wt % to 0.5 wt %. In some aspects, after performing the water gas shift reaction, the products from the water gas shift reaction stage can be separated to form a stream with a higher concentration of H₂ and/or synthesis gas. Some separations, such as removal of water and/or CO₂, can be performed in various ways. To form a still higher purity stream, a pressure swing adsorber is a suitable type of separation system. Alternatively, the components present in the input feeds to the water gas shift reaction are generally compatible with a hydrogenation reaction environment or a Fischer-Tropsch reaction environment, so the shifted product from the water gas shift reaction stage can be used without further separation if desired.

### Partial Hydrogenation of Biomass Oil

In some aspects, the biomass oil can be partially hydrogenated prior to co-processing the biomass oil with a conventional feed in an FCC reactor. Hydrogenation of the biomass oil can improve the quality of the biomass oil in order to extend the run length of the FCC reactor. The hydrogenation can be performed under sufficiently mild conditions so that at least a portion of the oxygen in the biomass oil remains in the biomass oil. This is in contrast to conventional hydroprocessing conditions, which are typically severe enough to remove oxygen from substantially all oxygen-containing compounds within a feedstock. In various aspects, the oxygen content of the biomass oil after hydrogenation can be 1.0 wt % to 8.0 wt %, or 1.0 wt % to 6.0 wt %, or 1.0 wt % to 4.0 wt %, or 2.0 wt % to 8.0 wt %, or 2.0 wt % to 6.0 wt %. This can correspond to conversion of 20 wt % to 70 wt % of the oxygen-containing compounds in the biomass oil to compounds that do not include oxygen, or 20 wt % to 50 wt %, or 40 wt % to 70 wt %.

In addition to converting some oxygen-containing compounds to non-oxygen-containing compounds, it is believed that the hydrogenation can also convert some types of oxygen-containing compounds in the biomass oil to compounds that are more favorable for formation of CO in the FCC overhead gas product. For example, without being bound by any particular theory, it is believed that under hydrogenation conditions, aromatic rings in the biomass oil that include a hydroxyl group (—OH) as a substituent can be converted to non-aromatic ketone functionalities.

The hydrogenation can be carried out in the presence of hydrogen. A hydrogen stream can be fed or injected into a vessel or reaction zone or hydrogenation zone corresponding to the location of a hydrogenation catalyst. Hydrogen, contained in a hydrogen “treat gas,” can be provided to the reaction zone. Treat gas, as referred to herein, can be either pure hydrogen or a hydrogen-containing gas stream containing hydrogen in an amount that for the intended reaction(s). Treat gas can optionally include one or more other gasses (e.g., nitrogen and light hydrocarbons such as methane) that do not adversely interfere with or affect either the reactions or the products. Impurities, such as H₂S and NH₃ are undesirable and can typically be removed to a sufficiently low level from the treat gas before conducting the treat gas to the reactor. In some aspects, the treat gas can substantially consist of hydrogen (i.e., 99 vol % or more H₂). In other aspects, the treat gas stream introduced into a reaction stage can contain 10 vol % or more of hydrogen, or 30 vol % or more, or 50 vol % or more, or 70 vol % or more, such as up to substantially consisting of hydrogen.

In some aspects, an unexpected synergy can be achieved by using hydrogen generated from the FCC main column overhead product gas stream as the hydrogen treat gas for the partial hydrogenation of the biomass oil. In such aspects, the H₂ concentration in the hydrogen treat gas can be relatively low, such as 10 vol % to 50 vol %. In other aspects, if one or more separations are performed on input streams to the water gas shift reaction stage and/or the H₂-containing output stream from the water gas shift reactions stage, the H₂ concentration in the hydrogen treat gas can be higher, such as 30 vol % up to being substantially composed of H₂, or 30 vol % to 70 vol %.

Effective hydrogenation conditions for partial hydrogenation of biomass oil can include temperatures in the range of 390° F. to 550° F. (˜200° C. to ˜290° C.); pressures in the range of 400 kPa-a to 1700 kPa-a (˜60 to ˜245 psia); a liquid hourly space velocity (LHSV) of from 0.1 hr⁻¹ to 50 hr⁻¹; and a hydrogen treat gas rate of from 43 to about 170 Nm³/m³ (˜250 to ˜1000 SCF/bbl).

The partial hydrogenation can be performed in the presence of a catalyst, such as a hydrotreating catalyst. Hydrotreating catalysts suitable for use herein can include those containing at least one Group VIA metal and/or at least one Group VIII metal, including mixtures thereof. Examples of suitable metals include Ni, W, Mo, Co and mixtures thereof, for example CoMo, NiMoW, NiMo, or NiW. These metals or mixtures of metals are typically present as oxides or sulfides on refractory metal oxide supports. The amount of metals for supported hydrotreating catalysts, either individually or in mixtures, can range from ˜0.5 to ˜35 wt %, based on the weight of the catalyst. Additionally or alternately, for mixtures of Group VIA and Group VIII metals, the Group VIII metals can be present in amounts of from ˜0.5 to ˜5 wt % based on catalyst, and the Group VIA metals can be present in amounts of from 5 to 30 wt % based on the catalyst. A mixture of metals may also be present as a bulk metal catalyst wherein the amount of metal can comprise ˜30 wt % or greater, based on catalyst weight. Suitable metal oxide supports for the hydrotreating catalysts include oxides such as silica, alumina, silica-alumina, titania, or zirconia. Examples of aluminas suitable for use as a support can include porous aluminas such as gamma or eta. Optionally, the hydrotreating catalyst can correspond to a “spent” hydrotreating catalyst that has a lower activity due to prior use in another type of hydrotreating service.

Feed for Co-Processing with Biomass Oil

After forming biomass oil, and after any optional hydrogenation of the biomass oil, the biomass oil can be co-processed with another feedstock, such as a mineral vacuum gas oil feed. Optionally, the feedstock for co-processing with the biomass oil can be hydroprocessed prior to exposure to the FCC reaction environment. Relative to the combined feed for co-processing, the biomass oil can correspond to 10 wt % to 75 wt % of the combined feed, or 10 wt % to 50 wt %, or 25 wt % to 75 wt %, or 25 wt % to 50 wt %, or 50 wt % to 75 wt %. In some aspects, higher proportions of biomass oil can be co-processed when partial hydrogenation is performed on the biomass oil prior to co-processing.

A wide range of petroleum and chemical feedstocks can be hydroprocessed to form an FCC input feed suitable for low temperature/high conversion FCC processing. Suitable feedstocks include whole and reduced petroleum crudes, atmospheric, cycle oils, gas oils, including vacuum gas oils and coker gas oils, light to heavy distillates including raw virgin distillates, hydrocrackates, hydrotreated oils, extracts, slack waxes, Fischer-Tropsch waxes, raffinates, and mixtures of these materials.

Suitable feeds for hydroprocessing to form an FCC input feed can include, for example, feeds with an initial boiling point and/or a T5 boiling point and/or T10 boiling point of at least ˜600° F. (˜316° C.), or at least ˜650° F. (˜343° C.), or at least ˜700° F. (371° C.), or at least ˜750° F. (˜399° C.). Additionally or alternately, the final boiling point and/or T95 boiling point and/or T90 boiling point of the feed can be ˜1100° F. (˜593° C.) or less, or ˜1050° F. (˜566° C.) or less, or ˜1000° F. (˜538° C.) or less, or ˜950° F. (˜510° C.) or less. In particular, a feed can have a T5 to T95 boiling range of ˜316° C. to ˜593° C., or a T5 to T95 boiling range of ˜343° C. to ˜566° C., or a T10 to T90 boiling range of ˜343° C. to ˜566° C. Optionally, it can be possible to use a feed that includes a lower boiling range portion. Such a feed can have an initial boiling point and/or a T5 boiling point and/or T10 boiling point of at least ˜350° F. (˜177° C.), or at least ˜400° F. (˜204° C.), or at least ˜450° F. (˜232° C.). In particular, such a feed can have a T5 to T95 boiling range of ˜177° C. to ˜593° C., or a T5 to T95 boiling range of ˜232° C. to ˜566° C., or a T10 to T90 boiling range of ˜177° C. to ˜566° C.

In some aspects, the feed for hydroprocessing to form an FCC input feed can have a sulfur content of ˜500 wppm to ˜50000 wppm or more, or ˜500 wppm to ˜20000 wppm, or ˜500 wppm to ˜10000 wppm. Additionally or alternately, the nitrogen content of such a feed can be ˜20 wppm to ˜8000 wppm, or ˜50 wppm to ˜4000 wppm. In some aspects, the feed can correspond to a “sweet” feed, so that the sulfur content of the feed can be ˜10 wppm to ˜500 wppm and/or the nitrogen content can be ˜1 wppm to ˜100 wppm.

Prior to FCC processing, a feedstock for co-processing can be hydrotreated. An example of a suitable type of hydrotreatment can be hydrotreatment under trickle bed conditions. Hydrotreatment can be used, optionally in conjunction with other hydroprocessing, to form an input feed for FCC processing based on an initial feed. As noted above, the initial feed can correspond to a catalytic slurry oil and/or a feed including a vacuum gas oil boiling range portion.

Hydroprocessing (such as hydrotreating) can be carried out in the presence of hydrogen. A hydrogen stream can be fed or injected into a vessel or reaction zone or hydroprocessing zone corresponding to the location of a hydroprocessing catalyst. Hydrogen, contained in a hydrogen “treat gas,” can be provided to the reaction zone. Treat gas, as referred to herein, can be either pure hydrogen or a hydrogen-containing gas stream containing hydrogen in an amount that for the intended reaction(s). Treat gas can optionally include one or more other gasses (e.g., nitrogen and light hydrocarbons such as methane) that do not adversely interfere with or affect either the reactions or the products. Impurities, such as H₂S and NH₃ are undesirable and can typically be removed from the treat gas before conducting the treat gas to the reactor. In aspects where the treat gas stream can differ from a stream that substantially consists of hydrogen (i.e., at least 99 vol % hydrogen), the treat gas stream introduced into a reaction stage can contain at least 50 vol %, or at least 75 vol % hydrogen, or at least 90 vol % hydrogen.

During hydrotreatment, a feedstock can be contacted with a hydrotreating catalyst under effective hydrotreating conditions which include temperatures in the range of 450° F. to 800° F. (˜232° C. to ˜427° C.), or 550° F. to 750° F. (˜288° C. to ˜399° C.); pressures in the range of 1.5 MPag to 20.8 MPag (˜200 to ˜3000 psig), or 2.9 MPag to 13.9 MPag (˜400 to ˜2000 psig); a liquid hourly space velocity (LHSV) of from 0.1 to 10 hr⁻¹, or 0.1 to 5 hr⁻¹; and a hydrogen treat gas rate of from 430 to 2600 Nm³/m³ (˜2500 to ˜15000 SCF/bbl), or 850 to 1700 Nm³/m³ (˜5000 to ˜10000 SCF/bbl).

In an aspect, the hydrotreating step may comprise at least one hydrotreating reactor, and optionally may comprise two or more hydrotreating reactors arranged in series flow. A vapor separation drum can optionally be included after each hydrotreating reactor to remove vapor phase products from the reactor effluent(s). The vapor phase products can include hydrogen, H₂S, NH₃, and hydrocarbons containing four (4) or less carbon atoms (i.e., “C₄-hydrocarbons”). Optionally, a portion of the C₃ and/or C₄ products can be cooled to form liquid products. The effective hydrotreating conditions can be suitable for removal of at least about 70 wt %, or at least about 80 wt %, or at least about 90 wt % of the sulfur content in the feedstream from the resulting liquid products. Additionally or alternately, at least about 50 wt %, or at least about 75 wt % of the nitrogen content in the feedstream can be removed from the resulting liquid products. In some aspects, the final liquid product from the hydrotreating unit can contain less than about 1000 ppmw sulfur, or less than about 500 ppmw sulfur, or less than about 300 ppmw sulfur, or less than about 100 ppmw sulfur.

The effective hydrotreating conditions can optionally be suitable for incorporation of a substantial amount of additional hydrogen into the hydrotreated effluent. During hydrotreatment, the consumption of hydrogen by the feed in order to form the hydrotreated effluent can correspond to at least 1500 SCF/bbl (˜260 Nm³/m³) of hydrogen, or at least 1700 SCF/bbl (˜290 Nm³/m³), or at least 2000 SCF/bbl (˜330 Nm³/m³), or at least 2200 SCF/bbl (˜370 Nm³/m³), such as up to 5000 SCF/bbl (˜850 Nm³/m³) or more. In particular, the consumption of hydrogen can be 1500 SCF/bbl (˜260 Nm³/m³) to 5000 SCF/bbl (˜850 Nm³/m³), or 2000 SCF/bbl (˜340 Nm³/m³) to 5000 SCF/bbl (˜850 Nm³/m³), or 2200 SCF/bbl (˜370 Nm³/m³) to 5000 SCF/bbl (˜850 Nm³/m³).

Hydrotreating catalysts suitable for use herein can include those containing at least one Group VIA metal and at least one Group VIII metal, including mixtures thereof. Examples of suitable metals include Ni, W, Mo, Co and mixtures thereof, for example CoMo, NiMoW, NiMo, or NiW. These metals or mixtures of metals are typically present as oxides or sulfides on refractory metal oxide supports. The amount of metals for supported hydrotreating catalysts, either individually or in mixtures, can range from ˜0.5 to ˜35 wt %, based on the weight of the catalyst. Additionally or alternately, for mixtures of Group VIA and Group VIII metals, the Group VIII metals can be present in amounts of from ˜0.5 to ˜5 wt % based on catalyst, and the Group VIA metals can be present in amounts of from 5 to 30 wt % based on the catalyst. A mixture of metals may also be present as a bulk metal catalyst wherein the amount of metal can comprise ˜30 wt % or greater, based on catalyst weight. Suitable metal oxide supports for the hydrotreating catalysts include oxides such as silica, alumina, silica-alumina, titania, or zirconia. Examples of aluminas suitable for use as a support can include porous aluminas such as gamma or eta.

### FCC Processing Conditions

An example of a suitable reactor for performing an FCC process can be a riser reactor. Within the reactor riser, the feeds for co-processing can be contacted with a catalytic cracking catalyst under cracking conditions thereby resulting in spent catalyst particles containing carbon deposited thereon and a lower boiling product stream. The cracking conditions can include: temperatures from 900° F. to 1060° F. (˜482° C. to ˜571° C.), or 950° F. to 1040° F. (˜510° C. to ˜560° C.); hydrocarbon partial pressures from 10 to 50 psia (˜70-350 kPa-a), or from 20 to 40 psia (˜140-280 kPa-a); and a catalyst to feed (wt/wt) ratio from 3 to 8, or 5 to 6, where the catalyst weight can correspond to total weight of the catalyst composite. Steam may be concurrently introduced with the feed into the reaction zone. The steam may comprise up to 5 wt % of the feed. In some aspects, the FCC feed residence time in the reaction zone can be less than 5 seconds, or from 3 to 5 seconds, or from 2 to 3 seconds.

Catalysts suitable for use within the FCC reactor herein can be fluid cracking catalysts comprising either a large-pore molecular sieve or a mixture of at least one large-pore molecular sieve catalyst and at least one medium-pore molecular sieve catalyst. Large-pore molecular sieves suitable for use herein can be any molecular sieve catalyst having an average pore diameter greater than ˜0.7 nm which are typically used to catalytically “crack” hydrocarbon feeds. In various aspects, both the large-pore molecular sieves and the medium-pore molecular sieves used herein be selected from those molecular sieves having a crystalline tetrahedral framework oxide component. For example, the crystalline tetrahedral framework oxide component can be selected from the group consisting of zeolites, tectosilicates, tetrahedral aluminophosphates (ALPOs) and tetrahedral silicoaluminophosphates (SAPOs). Preferably, the crystalline framework oxide component of both the large-pore and medium-pore catalyst can be a zeolite. More generally, a molecular sieve can correspond to a crystalline structure having a framework type recognized by the International Zeolite Association. It should be noted that when the cracking catalyst comprises a mixture of at least one large-pore molecular sieve catalyst and at least one medium-pore molecular sieve, the large-pore component can typically be used to catalyze the breakdown of primary products from the catalytic cracking reaction into clean products such as naphtha and distillates for fuels and olefins for chemical feedstocks.

Large pore molecular sieves that are typically used in commercial FCC process units can be suitable for use herein. FCC units used commercially generally employ conventional cracking catalysts which include large-pore zeolites such as USY or REY. Additional large pore molecular sieves that can be employed in accordance with the present invention include both natural and synthetic large pore zeolites. Non-limiting examples of natural large-pore zeolites include gmelinite, chabazite, dachiardite, clinoptilolite, faujasite, heulandite, analcite, levynite, erionite, sodalite, cancrinite, nepheline, lazurite, scolecite, natrolite, offretite, mesolite, mordenite, brewsterite, and ferrierite. Non-limiting examples of synthetic large pore zeolites are zeolites X, Y, A, L. ZK-4, ZK-5, B, E, F, H, J, M, Q, T, W, Z, alpha and beta, omega, REY and USY zeolites. In some aspects, the large pore molecular sieves used herein can be selected from large pore zeolites. In such aspects, suitable large-pore zeolites for use herein can be the faujasites, particularly zeolite Y, USY, and REY.

Medium-pore size molecular sieves that are suitable for use herein include both medium pore zeolites and silicoaluminophosphates (SAPOs). Medium pore zeolites suitable for use in the practice of the present invention are described in “Atlas of Zeolite Structure Types”, eds. W. H. Meier and D. H. Olson, Butterworth-Heineman, Third Edition, 1992, hereby incorporated by reference. The medium-pore size zeolites generally have an average pore diameter less than about 0.7 nm, typically from about 0.5 to about 0.7 nm and includes for example, MFI, MFS, MEL, MTW, EUO, MTT, HEU, FER, and TON structure type zeolites (IUPAC Commission of Zeolite Nomenclature). Non-limiting examples of such medium-pore size zeolites, include ZSM-5, ZSM-12, ZSM-22, ZSM-23, ZSM-34, ZSM-35, ZSM-38, ZSM-48, ZSM-50, silicalite, and silicalite 2. An example of a suitable medium pore zeolite can be ZSM-5, described (for example) in U.S. Pat. Nos. 3,702,886 and 3,770,614. Other suitable zeolites can include ZSM-11, described in U.S. Pat. No. 3,709,979; ZSM-12 in U.S. Pat. No. 3,832,449; ZSM-21 and ZSM-38 in U.S. Pat. No. 3,948,758; ZSM-23 in U.S. Pat. No. 4,076,842; and ZSM-35 in U.S. Pat. No. 4,016,245. As mentioned above SAPOs, such as SAPO-11, SAPO-34, SAPO-41, and SAPO-42, described (for example) in U.S. Pat. No. 4,440,871 can also be used herein. Non-limiting examples of other medium pore molecular sieves that can be used herein include chromosilicates; gallium silicates; iron silicates; aluminum phosphates (ALPO), such as ALPO-11 described in U.S. Pat. No. 4,310,440; titanium aluminosilicates (TASO), such as TASO-45 described in EP-A No. 229,295; boron silicates, described in U.S. Pat. No. 4,254,297; titanium aluminophosphates (TAPO), such as TAPO-11 described in U.S. Pat. No. 4,500,651 and iron aluminosilicates. All of the above patents are incorporated herein by reference.

The medium-pore size zeolites (or other molecular sieves) used herein can include “crystalline admixtures” which are thought to be the result of faults occurring within the crystal or crystalline area during the synthesis of the zeolites. Examples of crystalline admixtures of ZSM-5 and ZSM-11 can be found in U.S. Pat. No. 4,229,424, incorporated herein by reference. The crystalline admixtures are themselves medium-pore size zeolites, in contrast to physical admixtures of zeolites in which distinct crystals of crystallites of different zeolites are physically present in the same catalyst composite or hydrothermal reaction mixtures.

In some aspects, the large-pore zeolite catalysts and/or the medium-pore zeolite catalysts can be present as “self-bound” catalysts, where the catalyst does not include a separate binder. In some aspects, the large-pore and medium-pore catalysts can be present in an inorganic oxide matrix component that binds the catalyst components together so that the catalyst product can be hard enough to survive inter-particle and reactor wall collisions. The inorganic oxide matrix can be made from an inorganic oxide sol or gel which can be dried to “glue” the catalyst components together. Preferably, the inorganic oxide matrix can be comprised of oxides of silicon and aluminum. It can be preferred that separate alumina phases be incorporated into the inorganic oxide matrix. Species of aluminum oxyhydroxides-γ-alumina, boehmite, diaspore, and transitional aluminas such as α-alumina, β-alumina, γ-alumina, δ-alumina, ε-alumina, κ-alumina, and ρ-alumina can be employed. Preferably, the alumina species can be an aluminum trihydroxide such as gibbsite, bayerite, nordstrandite, or doyelite. Additionally or alternately, the matrix material may contain phosphorous or aluminum phosphate. Optionally, the large-pore catalysts and medium-pore catalysts be present in the same or different catalyst particles, in the aforesaid inorganic oxide matrix.

In the FCC reactor, the cracked FCC product can be removed from the fluidized catalyst particles. Preferably this can be done with mechanical separation devices, such as an FCC cyclone. The FCC product can be removed from the reactor via an overhead line, cooled and sent to a fractionator tower for separation into various cracked hydrocarbon product streams. These product streams may include, but are not limited to, a light gas stream (generally comprising C₄ and lighter hydrocarbon materials), a naphtha (gasoline) stream, a distillate (diesel and/or jet fuel) steam, and other various heavier gas oil product streams. The other heavier stream or streams can include a bottoms stream.

In the FCC reactor, after removing most of the cracked FCC product through mechanical means, the majority of, and preferably substantially all of, the spent catalyst particles can be conducted to a stripping zone within the FCC reactor. The stripping zone can typically contain a dense bed (or “dense phase”) of catalyst particles where stripping of volatiles takes place by use of a stripping agent such as steam. There can also be space above the stripping zone with a substantially lower catalyst density which space can be referred to as a “dilute phase”. This dilute phase can be thought of as either a dilute phase of the reactor or stripper in that it will typically be at the bottom of the reactor leading to the stripper.

In some aspects, the majority of, and preferably substantially all of, the stripped catalyst particles are subsequently conducted to a regeneration zone wherein the spent catalyst particles are regenerated by burning coke from the spent catalyst particles in the presence of an oxygen containing gas, preferably air thus producing regenerated catalyst particles. This regeneration step restores catalyst activity and simultaneously heats the catalyst to a temperature from 1200° F. to 1400° F. (˜649 to 760° C.). The majority of, and preferably substantially all of the hot regenerated catalyst particles can then be recycled to the FCC reaction zone where they contact injected FCC feed.

### Examples of Reaction System Configurations

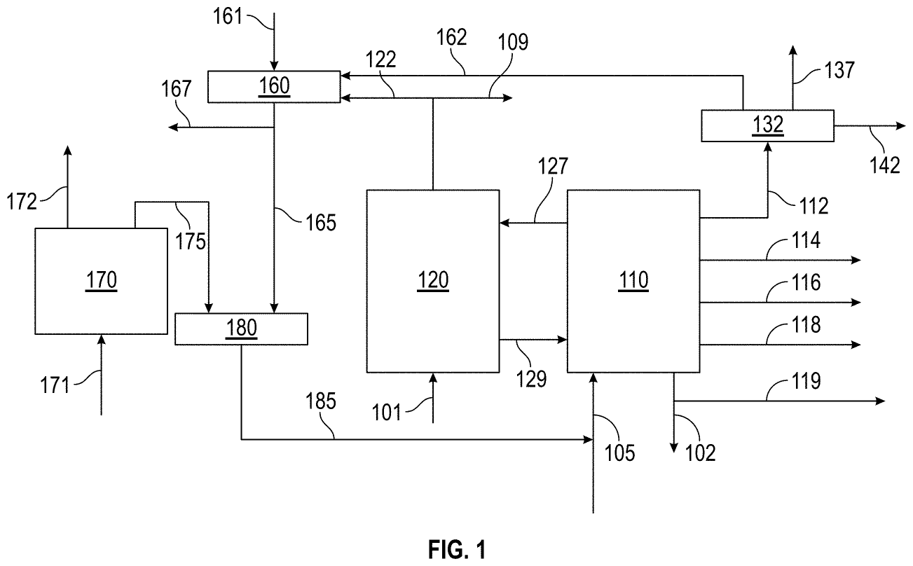

FIG. 1 shows an example of a reaction system for co-processing of biomass oil with a vacuum gas oil boiling range feedstock for FCC processing. The vacuum gas oil boiling range feedstock can correspond to 25 wt % to 90 wt % of the combined feed, or 25 wt % to 75 wt %, or 25 wt % to 50 wt %.

In FIG. 1, a feedstock 105 is co-processed with a biomass oil feed 185 in an FCC reaction system 110. In the configuration shown in FIG. 1, reaction system 110 can include a reactor plus associated separation stages. The feedstock 105 can correspond to, for example, a vacuum gas oil boiling range fraction, or another type of fraction that is typically processed in an FCC reactor. The FCC reaction system 110 can convert a portion of feedstock 105 and biomass oil feed 185 to form various products. These products can include a C₄₋ product 112, a naphtha boiling range product 114, a light cycle oil 116, a heavy cycle oil 118, clarified slurry oil 119, and a recycle portion 102. It is noted that heavy cycle 118, clarified slurry oil 119, and recycle portion 102 can correspond to unconverted products relative to a conversion temperature of 343° C. In aspects where biomass oil feed 185 corresponds to 10 wt % or more of the combined feed, C₄₋ product 112 can include CO. The C₄₋ product 112 can be passed into a gas plant 132 to separate a C₃-C₄ fraction 142 from a remaining overhead product gas 162. The gas plant 132 can optionally also separate out sulfur and/or nitrogen containing compounds 137 (such as H₂S or NH₃), so that the overhead gas product 162 contains a reduced or minimized amount of such compounds.

During operation of the FCC reactor 110, coke can form on the catalyst within the reactor. This spent coke 127 can be withdrawn into regenerator 120 to form regenerated catalyst 129 and a regenerator flue gas 122. A portion 109 of regenerator flue gas 122 can optionally be used as a fuel gas and/or used for another purpose and/or sent to an exhaust stage. In aspects where regenerator 120 is operated in a partial regeneration mode, regenerator flue gas 122 can include CO.

The biomass oil 185 can be formed by exposing biomass 171 to a biomass conversion stage 170. In the example shown in FIG. 1, the biomass conversion stage corresponds to a pyrolysis process, but other types of conversion processes can also be used. Examples of pyrolysis processes suitable for biomass conversion stage 170 in FIG. 1 include, but are not limited to, hydrothermal liquefaction, fast pyrolysis, and catalytic pyrolysis. Biomass conversion stage 170 can generate a raw biomass oil 175 and a light gas product 172. Light gas product 172 can include CO.

In the configuration shown in FIG. 1, regenerator flue gas 122, and overhead product gas 162 are passed into a water gas shift stage 160. Introduction of regenerator flue gas 122 into the water gas shift stage 160 is optional, depending on the amount of coke formed during the FCC reaction (i.e., depending on whether the regenerator is operated in a partial regeneration mode so that CO would be formed). Steam can also be introduced into water gas shift stage 160 to facilitate additional hydrogen formation. After exposure to water gas shift conditions, a separation can be performed to separate H₂-containing stream 165 from a remaining fuel gas portion 167. The H₂-containing stream 165 can then be used for partial hydrogenation of the raw biomass oil 175 in partial hydrogenation stage 180. This can allow for formation of biomass oil feed 185.

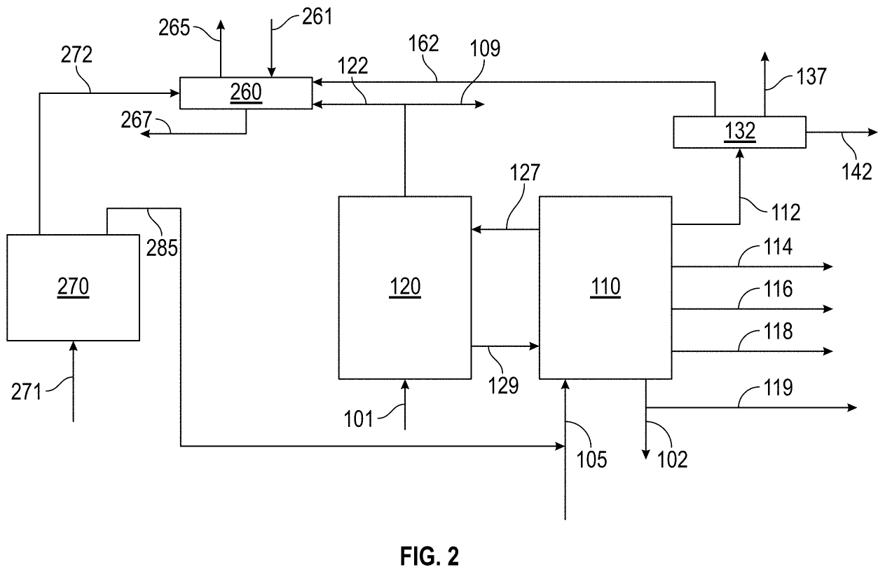

FIG. 2 shows an example of another configuration for co-processing of biomass oil in an FCC reaction system. In the configuration shown in FIG. 2, instead of making hydrogen, the CO-containing streams are used to form a synthesis gas product. Additionally, in the configuration shown in FIG. 2, after passing through a separation stage, the light gas from biomass conversion is added to the gas streams that are passed into the water gas shift separation stage.

In FIG. 2, the biomass oil 285 for co-processing is still derived from biomass conversion 270 of biomass 271, such as by a pyrolysis process. However, a hydrogenation stage is not included. Instead, the biomass oil 285 in FIG. 2 corresponds to the raw biomass oil formed in biomass conversion stage 270. It is noted that a partial hydrogenation stage (not shown) could be included if desired, and/or other stages for pre-processing of the biomass oil 285, so long as sufficient oxygen remains for CO to be present in the overhead gas product 162.

The biomass conversion stage 270 produces a light gas product 272 that contains CO. In FIG. 2, this is shown as being passed into the water gas shift stage 260, but this is optional. Preferably, if light gas product 272 is passed into water gas shift stage 260, one or more separations (not shown) are performed on the light gas product 272 to sulfur compounds, nitrogen compounds, and/or particulates before introduction into the water gas shift stage 260. Addition of regenerator flue gas 122 to water gas shift stage 260 is also optional. The addition of steam 261 is also optional. In water gas shift stage 260, instead of attempting to drive the product to form H₂ from substantially all of the CO, in the configuration shown in FIG. 2 that water gas shift conditions can be selected to generate a synthesis gas with an H₂ to CO ratio of roughly 1.8 to 2.2.

### Example 1—Co-Processing of Biomass Oil Formed by Various Processes

In order to investigate yields from co-processing of biomass oil in an FCC reaction system, several types of biomass oil were prepared or obtained. Some biomass oil was formed using hydrothermal liquefaction (HTL). The resulting HTL biomass oil included an oxygen content of 12.3 wt %. Other biomass oil was formed using a fast pyrolysis process, resulting in a biomass oil with an oxygen content of 42.7 wt %. Still other biomass oil corresponded to canola oil. The various types of biomass oil were then used in FCC co-processing in various amounts to investigate CO production during co-processing. Table 1 provides an elemental analysis for the pyrolysis biomass oils.

TABLE 1
Elemental Analysis of Biomass Oils

| WT. % | HTL | Fast Pyrolysis | Canola Oil |
|---|---|---|---|
| C | 75.9 | 44.2 | |
| H | 8.32 | 6.78 | |
| N | 0.16 | 0.18 | |
| O | 12.3 | 42.7 | |
| H2O | 3.6 | 21.7 | |

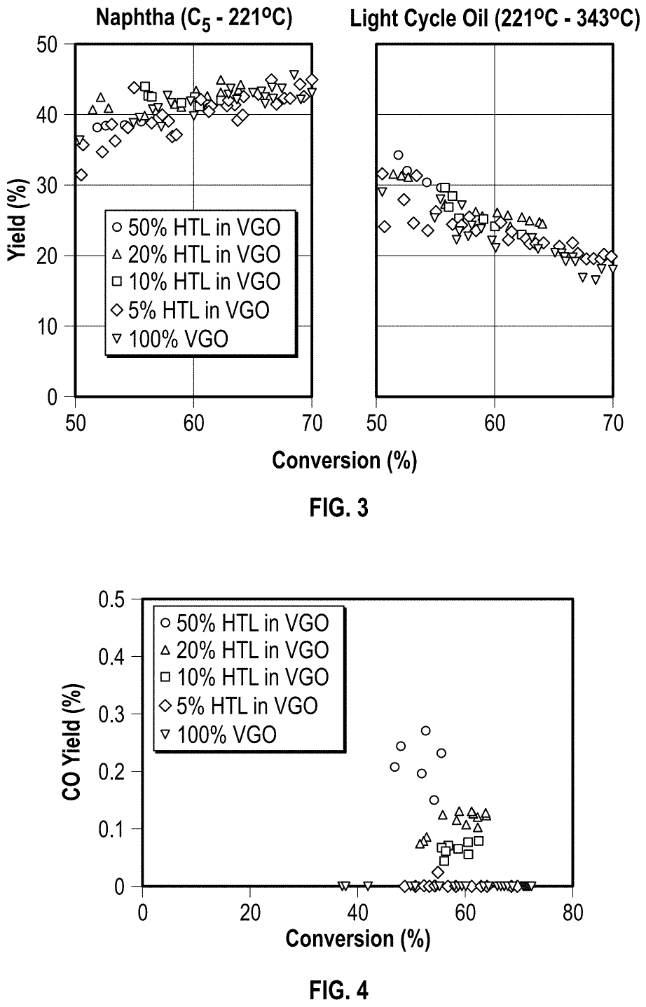

FIG. 3 and FIG. 4 show results from co-processing of the hydrothermal liquefaction biomass oil with a mineral vacuum gas oil feedstock in an FCC reaction system. The processing conditions in the FCC reactor were selected to achieve levels of conversion ranging from 50 wt % to 70 wt % relative to 343° C. The amount of biomass for co-processing ranged from 5 wt % of the combined feed to 50 wt %. A series of comparative runs that did not include biomass oil were also performed.

FIG. 3 shows yields of naphtha and light cycle oil from the FCC reactor, relative to the amount of conversion, for various mixtures of vacuum gas oil and biomass oil. As shown in FIG. 3, the yield for both naphtha and light cycle oil at a given level of conversion was relatively unchanged as the amount of biomass oil in the combined feedstock was increased. FIG. 3 demonstrates that co-processing of biomass oil does not result in a loss of liquid product yield for the desired conversion products of naphtha and light cycle oil.

FIG. 4 shows additional results from the co-processing runs. In FIG. 4, the yield of CO relative to the weight of the combined feed is shown for the various process runs shown in FIG. 3. As shown in FIG. 4, co-processing of 5.0 wt % or less of biomass oil did not result in CO production. However, CO is generated 10 wt % biomass oil or more is co-processed. The yield of CO increases with increasing amounts of biomass oil in the combined feedstock. Increasing the amount of conversion also appears to increase the amount of CO production. As noted above, due to the higher oxygen contents of biomass oil formed from the various types of pyrolysis, still higher CO levels are expected when co-processing biomass oil from such sources.

As a further illustration, Table 2 shows a comparison of products from co-processing 50 wt % biomass oil with the products from processing only the vacuum gas oil mineral feed. The data in Table 2 is from runs where 50 wt % conversion was performed on the feedstock.

TABLE 2
Products at 50 wt % Conversion for
HTL Biomass Oil Co-Processing

| Product yields relative | 50 wt % biomass oil/ | |
|---|---|---|
| to feed (wt %) | 50 wt % VGO | 100 wt % VGO |
| Naphtha | 36.1 | 42.7 |
| Light Cycle Oil (LCO) | 34.6 | 23.1 |
| Combined Naphtha and LCO | 70.7 | 65.8 |
| CO | 0.24 | 0 |
| CO₂ | 0.14 | 0.08 |
| H₂ | 0.05 | 0.09 |

In the example shown in Table 2, the combined amount of naphtha and light cycle oil from co-processing of biomass oil is slightly higher than the corresponding combined amount from processing of just the mineral vacuum gas oil feed. Co-processing of the biomass oil resulted in production of 0.24 wt % of CO. However, the amount of H₂ is reduced from 0.05 wt % to 0.09 wt %. In aspects where H₂ production is desired, additional H₂O could be added to the water gas shift reaction stage to drive additional H₂ formation. In aspects where synthesis gas production is desired, the additional CO₂ generated during co-processing would be beneficial for achieving a synthesis gas ratio closer to 2:1 while reducing or minimizing (or possibly eliminating) the addition of gases to the water gas shift environment.

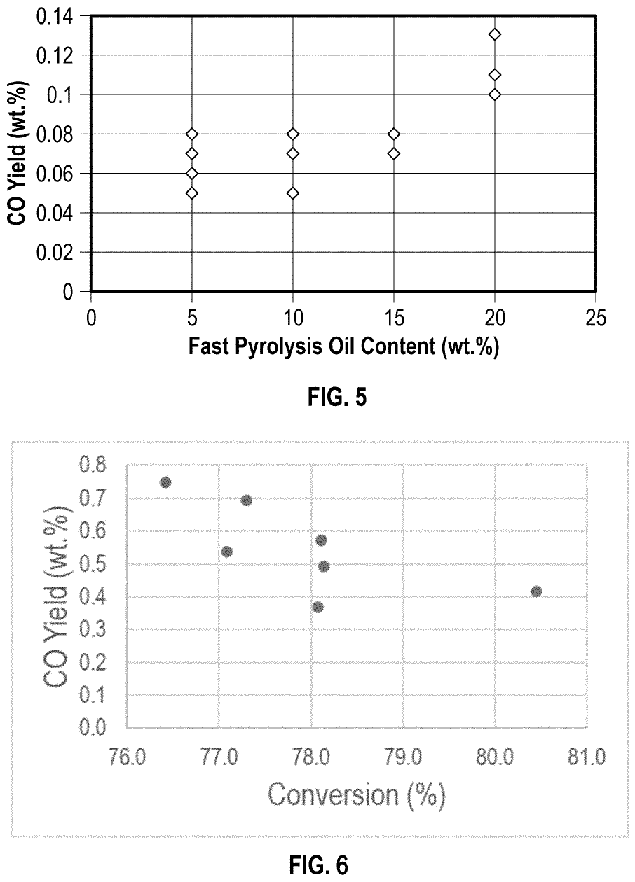

The yield of CO from processing of the other types of biomass oil was also characterized. FIG. 5 shows the yield of CO from FCC co-processing of the biomass oil derived from fast pyrolysis. FIG. 6 shows the yield of CO from FCC co-processing of 20 wt % canola oil at various levels of feed conversion. As shown in FIG. 5, FCC co-processing of the fast pyrolysis oil results in CO production, but the amount of CO produced does not appear to scale with the initial oxygen content of the biomass oil. FIG. 6 shows that there is some variation in CO production as the level of feed conversion is varied.

It is noted that in a commercial scale reactor, the CO production above can provide a substantial amount of synthesis gas. For example, in an FCC reaction system designed for processing 100 MBPD (mega barrels per day) of total fresh feed, a 0.2 wt % CO yield corresponds to nearly 600 ft³/min (scfm) of CO, or roughly 17 m³/m³ per minute.

### Example 2—Suppression of CO Formation by Hydrogen Donor Compounds

To further investigate CO formation under FCC processing conditions, model compound studies were performed using an FCC reactor. In the model compound studies, acetic acid and acetone were used as representative oxygen-containing compounds. FCC processing of these neat model compounds was compared with FCC co-processing of a mixture of acetone or acetic acid with a combination of methylcyclohexane (MCH) and methylcyclopentane (MCP). MCH and MCP were selected as representative hydrogen donor compounds with some similarity to the saturated ring structures that are often present in a vacuum gas oil fraction.

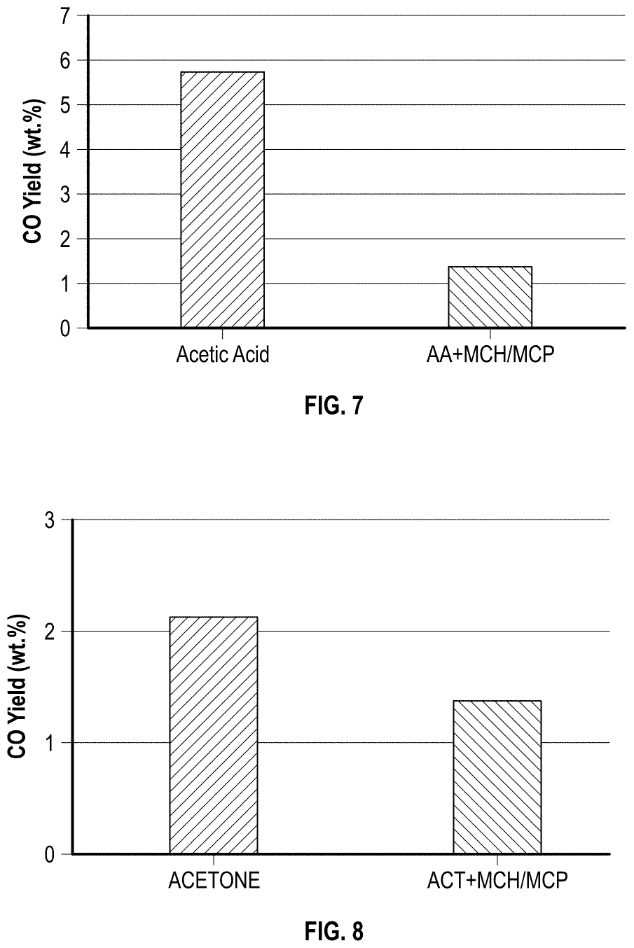

FIG. 7 shows the results from FCC processing of acetic acid alone and in a 50/50 (by weight) mixture with MCH and MCP. As shown in FIG. 7, FCC processing of acetic acid alone resulted in a CO yield of almost 6.0 wt % relative to the acetic acid feed. However, the feed with 50 wt % acetic acid mixed with MCH and MCP resulted in production of roughly 1.5 wt % of CO relative to the feed. As shown in FIG. 7, the drop in CO production is greater than the drop that would be expected just due to dilution with the hydrogen donor compounds.

FIG. 8 shows similar types of results for FCC processing of acetone. The yield of CO from processing acetone alone is somewhat greater than 2.0 wt %. However, the impact of the hydrogen donor compounds is substantially lower, so that the yield of CO from acetone in the 50/50 (by weight) mixture is similar to the roughly 1.5 wt % CO yield that was observed for acetic acid.

### Additional Embodiments

Embodiment 1. A method for co-processing biomass, comprising: exposing a biomass oil and a feedstock comprising vacuum gas oil to a catalyst in a reactor under fluid catalytic cracking conditions to form a C₄₋ fraction and one or more liquid product fractions, the at least a portion of the biomass oil comprising 10 wt % or more of a combined weight of the at least a portion of the biomass oil and the feedstock; separating a fraction comprising C₃-C₄ hydrocarbons and an overhead product gas fraction from the C₄₋ fraction; and contacting at least a portion of the overhead product gas fraction with a water gas shift catalyst to form at least an H₂-containing fraction.

Embodiment 2. The method of Embodiment 1, further comprising converting a biomass feed under biomass conversion conditions to form a light gas product and a liquid product, the biomass oil comprising at least a portion of the liquid product.

Embodiment 3. The method of Embodiment 1, further comprising exposing at least a portion of the biomass oil to hydrogenation conditions in the presence of at least a portion of the H₂-containing fraction to form a partially hydrogenated biomass oil having an oxygen content of 2.0 wt % or more, wherein the at least a portion of the biomass oil comprises an oxygen content of 5.0 wt % or more prior to exposing the at least a portion of the biomass oil to the hydrogenation conditions, and wherein exposing the biomass oil to the catalyst comprises exposing at least a portion of the partially hydrogenated biomass oil to the catalyst.

Embodiment 4. The method of any of the above embodiments, wherein exposing the biomass oil and a feedstock comprising vacuum gas oil to a catalyst under fluid catalytic cracking conditions further comprises forming partially spent catalyst with increased coke content, the method further comprising: regenerating at least a portion of the catalyst with increased coke content under partial regeneration conditions to form a regeneration flue gas comprising CO and regenerated catalyst; and returning a portion of the regenerated catalyst to the reactor, wherein the contacting comprises contacting at least a portion of the overhead product gas fraction and at least a portion of the regeneration flue gas with the water gas shift catalyst to form the at least an H₂-containing fraction.

Embodiment 5. The method of any of the above embodiments, wherein the at least a portion of the overhead gas product fraction is contacted with the water gas shift catalyst under shift conditions to form a shifted product comprising a greater concentration of H₂ than the at least a portion of the overhead gas product fraction, the shifted product comprising the H₂-containing fraction.

Embodiment 6. The method of any of Embodiments 1-5, wherein the at least a portion of the overhead gas product fraction is contacted with the water gas shift catalyst under shift conditions to form a shifted product comprising a greater concentration of CO than the at least a portion of the overhead gas product fraction, the shifted product comprising the H₂-containing fraction; or wherein the H₂-containing fraction comprises a molar ratio of H₂ to CO of 1.8 to 2.2; or a combination thereof.

Embodiment 7. The method of any of the above embodiments, wherein the biomass oil comprises a pyrolysis oil.

Embodiment 8. The method of any of the above embodiments, wherein the biomass oil comprises 50 wt % or more of a combined weight of the biomass oil and the feedstock comprising vacuum gas oil.

Embodiment 9. The method of any of the above embodiments, wherein the overhead product gas fraction comprises 0.2 wt % or more CO relative to the combined weight of the at least a portion of the biomass oil and the feedstock.

Embodiment 10. The method of any of the above embodiments, wherein the one or more liquid product fractions comprise a naphtha fraction, a light cycle oil fraction, or a combination thereof.

Embodiment 11. The method of any of Embodiments 2-10, wherein the contacting comprises separating at least a portion of the light gas product from one or more remaining portions of the light gas product, and contacting at least a portion of the overhead product gas fraction and at least a portion of the light gas product with the water gas shift catalyst to form the fraction comprising H₂ and CO.

Embodiment 12. A biomass co-processing system, comprising: a biomass conversion unit comprising a biomass inlet and a conversion product outlet; a hydrogenation stage comprising a hydrogenation feed inlet, a hydrogen inlet, and a hydrogenated product outlet, the hydrogenation feed inlet being in fluid communication with the conversion product outlet; a fluid catalytic cracking (FCC) reactor comprising an FCC feed inlet, a regenerated catalyst inlet, a spent catalyst outlet, a reactor gas outlet, and a one or more product outlets, the FCC feed inlet being in fluid communication with the hydrogenated product outlet and a second feed source; a gas plant comprising a gas plant inlet, one or more gas plant product outlets, and an overhead product outlet, the gas plant inlet being in fluid communication with the reactor gas outlet; an FCC regenerator comprising a regenerator gas inlet, a regenerator flue gas outlet, a spent catalyst inlet in solids flow communication with the spent catalyst outlet, and a regenerated catalyst outlet in solids flow communication with the regenerated catalyst inlet; and a water gas shift reaction stage comprising a shift reaction inlet and a shift reaction outlet, the shift reaction inlet being in fluid communication with the overhead product outlet of the gas plant, the shift reaction outlet being in fluid communication with the hydrogen inlet of the hydrogenation stage.

Embodiment 13. The biomass co-processing system of Embodiment 12, wherein the shift reaction inlet is further in fluid communication with the regenerator flue gas outlet.

Embodiment 14. The biomass co-processing system of Embodiment 12 or 13, wherein the biomass conversion unit further comprises a light products outlet, the system further comprising a light products separation stage in fluid communication with the light products outlet, and wherein the shift reaction inlet is further in fluid communication with the light products outlet via the light products separation stage, the light product separation stage optionally comprising a gas-solids separator.

When numerical lower limits and numerical upper limits are listed herein, ranges from any lower limit to any upper limit are contemplated. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

The present invention has been described above with reference to numerous embodiments and specific examples. Many variations will suggest themselves to those skilled in this art in light of the above detailed description. All such obvious variations are within the full intended scope of the appended claims.

What is claimed is:

1. A method for co-processing biomass, comprising:
exposing a biomass oil to hydrogenation conditions in the presence of at least a portion of an H₂-containing fraction to form a partially hydrogenated biomass oil having an oxygen content of 2.0 wt % or more;
exposing at least a portion of the partially hydrogenated biomass oil and a feedstock comprising a vacuum gas oil boiling fraction to a catalyst in a reactor under fluid catalytic cracking conditions to form a C₄₋ fraction and one or more liquid product fractions, the at least a portion of the partially hydrogenated biomass oil comprising 10 wt % or more of a combined weight of the at least a portion of the partially hydrogenated biomass oil and the feedstock;
separating a fraction comprising C₃-C₄ hydrocarbons and an overhead product gas fraction comprising CO from the C₄₋ fraction; and
contacting at least a portion of the overhead product gas fraction with a water gas shift catalyst to form at least the H₂-containing fraction.

2. The method of claim 1, wherein exposing the at least a portion of the partially hydrogenated biomass oil and the feedstock to a catalyst under fluid catalytic cracking conditions further comprises forming partially spent catalyst with increased coke content, the method further comprising:
regenerating at least a portion of the partially spent catalyst with increased coke content to form a regeneration flue gas and regenerated catalyst; and
returning a portion of the regenerated catalyst to the reactor.

3. The method of claim 2, wherein the regenerating of the at least a portion of the partially spent catalyst comprises regenerating under partial regeneration conditions to form a regeneration flue gas comprising CO, and wherein the contacting comprises contacting at least a portion of the overhead product gas fraction and at least a portion of the regeneration flue gas with the water gas shift catalyst to form at least the H₂-containing fraction.

4. The method of claim 1, wherein the biomass oil comprises a pyrolysis oil.

5. The method of claim 1, wherein the at least a portion of the partially hydrogenated biomass oil comprises 50 wt % or more of a combined weight of the at least a portion of the partially hydrogenated biomass oil and the feedstock comprising vacuum gas oil.

6. The method of claim 1, wherein the biomass oil comprises an oxygen content of 5.0 wt % or more prior to exposing the biomass oil to the hydrogenation conditions.

7. The method of claim 1, wherein the overhead product gas fraction comprises 0.1 wt % or more CO relative to the combined weight of the at least a portion of the partially hydrogenated biomass oil and the feedstock.

8. The method of claim 1, wherein the one or more liquid product fractions comprise a naphtha fraction, a light cycle oil fraction, or a combination thereof.

9. The method of claim 1, further comprising converting a biomass feed under biomass conversion conditions to form a light gas product and a liquid product, the biomass oil comprising at least a portion of the liquid product.

10. A method for co-processing biomass, comprising:
exposing biomass oil having an oxygen content of 5.0 wt % or more and a feedstock comprising vacuum gas oil to a catalyst in a reactor under fluid catalytic cracking conditions to form a C₄₋ fraction and one or more liquid product fractions, the at least a portion of the biomass oil comprising 10 wt % or more of a combined weight of the at least a portion of the biomass oil and the feedstock;
separating a fraction comprising C₃-C₄ hydrocarbons and an overhead product gas fraction from the C₄₋ fraction; and
contacting at least a portion of the overhead product gas fraction with a water gas shift catalyst to form a fraction comprising H₂ and CO.

11. The method of claim 10, further comprising converting a biomass feed under biomass conversion conditions to form a light gas product and a liquid product, the biomass oil comprising at least a portion of the liquid product.

12. The method of claim 11, wherein the contacting comprises contacting at least a portion of the overhead product gas fraction and at least a portion of the light gas product with the water gas shift catalyst to form the fraction comprising H₂ and CO.

13. The method of claim 10, wherein exposing the biomass oil and a feedstock comprising vacuum gas oil to a catalyst under fluid catalytic cracking conditions further comprises forming partially spent catalyst with increased coke content, the method further comprising:
regenerating at least a portion of the catalyst with increased coke content under partial regeneration conditions to form a regeneration flue gas comprising CO and regenerated catalyst; and
returning a portion of the regenerated catalyst to the reactor,
wherein the contacting comprises contacting at least a portion of the overhead product gas fraction and at least a portion of the regeneration flue gas with the water gas shift catalyst to form the fraction comprising synthesis gas.

14. The method of claim 10, wherein the fraction comprising H₂ and CO comprises a molar ratio of H₂ to CO of 1.8 to 2.2.

15. The method of claim 10, wherein the overhead product gas fraction comprises 0.2 wt % or more CO relative to the combined weight of the biomass oil and the feedstock.

16. The method of claim 10, further comprising exposing at least a portion of the biomass oil to hydrogenation conditions in the presence of at least a portion of the fraction comprising H₂ and CO to form a partially hydrogenated biomass oil having an oxygen content of 2.0 wt % or more,
wherein exposing the biomass oil to the catalyst comprises exposing at least a portion of the partially hydrogenated biomass oil to the catalyst.

17. The method of claim 10, wherein the at least a portion of the overhead gas product fraction is contacted with the water gas shift catalyst under shift conditions to from a fraction comprising H₂ and CO that comprises a greater concentration of CO than the at least a portion of the overhead gas product fraction.

18. A biomass co-processing system, comprising:
a biomass conversion unit comprising a biomass inlet and a conversion product outlet;
a hydrogenation stage comprising a hydrogenation feed inlet, a hydrogen inlet, and a hydrogenated product outlet, the hydrogenation feed inlet being in fluid communication with the conversion product outlet;
an FCC reactor comprising an FCC feed inlet, a regenerated catalyst inlet, a spent catalyst outlet, a reactor gas outlet, and a one or more product outlets, the FCC feed inlet being in fluid communication with the hydrogenated product outlet and a second feed source;
a gas plant comprising a gas plant inlet, one or more gas plant product outlets, and an overhead product outlet, the gas plant inlet being in fluid communication with the reactor gas outlet;
an FCC regenerator comprising a regenerator gas inlet, a regenerator flue gas outlet, a spent catalyst inlet in solids flow communication with the spent catalyst outlet, and a regenerated catalyst outlet in solids flow communication with the regenerated catalyst inlet; and
a water gas shift reaction stage comprising a shift reaction inlet and a shift reaction outlet, the shift reaction inlet being in fluid communication with the overhead product outlet of the gas plant, the shift reaction outlet being in fluid communication with the hydrogen inlet of the hydrogenation stage.

19. The biomass co-processing system of claim 18, wherein the shift reaction inlet is further in fluid communication with the regenerator flue gas outlet.

20. The biomass co-processing system of claim 18, wherein the biomass conversion unit further comprises a light products outlet, the system further comprising a light products separation stage in fluid communication with the light products outlet, and wherein the shift reaction inlet is further in fluid communication with the light products outlet via the light products separation stage, the light products separation stage optionally comprising a gas-solids separator.
